(19) United States
(12) Patent Application Publication
(10) Pub. No.: US 2017/0336675 A1
(43) Pub. Date: Nov. 23, 2017

(54) DISPLAY DEVICE

(71) Applicant: Samsung Display Co. Ltd., Yongin-si (KR)

(72) Inventors: Sang Jae KIM, Yongin-si (KR); Kwang Hyun KIM, Gunpo-si (KR); Young Jin PARK, Suwon-si (KR); Yun JANG, Seongnam-si (KR)

(21) Appl. No.: 15/432,089

(22) Filed: Feb. 14, 2017

(30) Foreign Application Priority Data
May 18, 2016 (KR) 10-2016-0060721

(51) Int. Cl. G02F 1/1335; G02F 1/13363

(52) U.S. Cl. CPC G02F 1/133536; G02F 1/133636; G02F 1/133606; G02F 2202/043; G02F 2201/123; G02F 2001/133548; G02F 2001/133531; G02F 2202/36; G02F 2413/12; G02F 2001/133614

(57) ABSTRACT

A display device, in which a plurality of pixels is defined, includes: a first insulating substrate; a polarizer disposed on a surface of the first insulating substrate; a second insulating substrate which faces the surface of the first insulating substrate; and a liquid crystal layer interposed between the polarizer and the second insulating substrate, where the liquid crystal layer includes liquid crystals and a dichroic dye.

This application claims priority to Korean Patent Application No. 10-2016-0060721 filed on May 18, 2016, and all the benefits accruing therefrom under 35 U.S.C. §119, the content of which in its entirety is herein incorporated by reference.

### BACKGROUND

### 1. Field

Embodiments of the invention relate to a display device.

### 2. Description of the Related Art

The liquid crystal display device is one of the most widely used types of display device. In general, a liquid crystal display device includes a display panel including a liquid crystal layer, two polarizing plates located above and below the display panel, and a light source. The two polarizing plates and the liquid crystal layer serve as a shutter which adjusts the amount of passing light from the light source.

Each pixel of the liquid crystal display device may display a specific one of the primary colors to achieve a color display. A method of disposing a color filter for each pixel on an optical path extending from the light source to a viewer may be used as a method of allowing each pixel to display a single primary color. In such a method, the color filter may be disposed between the two polarizing plates to achieve a primary color by transmitting only a part of the wavelength band of the incident light and by absorbing other wavelength bands.

### SUMMARY

Since the two polarizing plates attached to upper and lower portions of the display panel are typically sensitive to the external environment, deformation or a warpage may occur in the display panel by moisture or heat, for example. Also, when omitting one of the two polarizing plates, the deformation or warpage problem of the display panel may become intensified.

When the liquid crystal display device is viewed from a front, the transmission axes of two polarizing plates may be viewed as being substantially or completely orthogonal to each other. However, when the viewer views the liquid crystal display device from a side, the two transmission axes may be viewed as not being substantially or completely orthogonal to each other. Such a warpage failure of the polarization axis may cause a deterioration of side visibility of the display device. Also, when a liquid crystal vertically moves in the liquid crystal layer, the alignment state of the liquid crystal may be differently viewed in accordance with the position of the viewer due to the warpage failure of the polarization axis, such that the deterioration of the side visibility may occur due to the refractive index anisotropy of the liquid crystal. Accordingly, a method for further improving the display quality of the liquid crystal display device is desired.

An embodiment of the invention provides a display device in which the deformation caused by moisture or heat is substantially minimized or effectively prevented.

Another embodiment of the invention provides a display device in which display quality is improved by improving the side visibility and by minimizing the color mixture defects such as leakage of light to adjacent pixels.

According to an exemplary embodiment of the invention, a display device in which a plurality of pixels is defined, includes a first insulating substrate; a polarizer disposed on a surface of the first insulating substrate; a second insulating substrate which faces the surface of the first insulating substrate; and a liquid crystal layer interposed between the polarizer and the second insulating substrate, where the liquid crystal layer includes liquid crystals and a dichroic dye.

In an exemplary embodiment, the plurality of pixels may include a first pixel which displays a first color, and a second pixel which displays a second color different from the first color, and the display device may further include a first wavelength conversion layer disposed in the first pixel, where the first wavelength conversion layer may include a first wavelength conversion material which converts a central wavelength of incident light into a wavelength of the first color; and a second wavelength conversion layer disposed in the second pixel, where the second wavelength conversion layer may include a second wavelength conversion material which converts the central wavelength of the incident light into a wavelength of the second color.

In an exemplary embodiment, the first wavelength conversion layer and the second wavelength conversion layer may be disposed between the second insulating substrate and the liquid crystal layer.

In an exemplary embodiment, each of the first wavelength conversion material and the second wavelength conversion material may include a quantum dot, a quantum rod or a phosphor material.

In an exemplary embodiment, the polarizer may be a reflective polarizer.

In an exemplary embodiment, the display device may further include: a phase difference layer that is disposed between the reflective polarizer and the liquid crystal layer.

In an exemplary embodiment, the phase difference layer may include a first phase difference layer as a uniaxial phase difference layer disposed on the reflective polarizer, and a second phase difference layer as a uniaxial phase difference layer disposed on the first phase difference layer.

In an exemplary embodiment, the phase difference layer may include a first phase difference layer disposed on the reflective polarizer, where the first phase difference layer is a uniaxial phase difference layer, and a second phase difference layer disposed on the first phase difference layer, where the second phase difference layer is a uniaxial phase difference layer.

In an exemplary embodiment, the phase difference layer may include a biaxial phase difference layer having an Nz coefficient greater than zero (0) and less than about 1.

In an exemplary embodiment, a ground axis of the phase difference layer may be parallel to a transmission axis or a reflection axis of the reflective polarizer.

In an exemplary embodiment, the display device may further include: a pixel electrode disposed between the phase difference layer and the liquid crystal layer, where the pixel electrode may be disposed in each of the plurality of pixels.

In an exemplary embodiment, the plurality of pixels may further include a third pixel which displays a third color different from the first color and the second color, and the display device may further include a light transmitting layer disposed on the third pixel.

In an exemplary embodiment, the display device may further including: a light source disposed on an opposite surface of the first insulating substrate and provides light having a central wavelength shorter than a central wavelength of the first color and a central wavelength of the second color.

In an exemplary embodiment, the light transmitting layer may include a light transmitting resin, and a light scattering particle dispersed in the light transmitting resin.

In an exemplary embodiment, an azimuth formed by a long axis of the liquid crystal on a plane in an initial alignment state where no electric field is applied to the liquid crystal layer may be parallel to the transmission axis of the polarizer.

In an exemplary embodiment, an azimuth formed by a long axis of the liquid crystal on a plane in a state where an electric field is applied to the liquid crystal layer may be parallel to the transmission axis of the polarizer.

In an exemplary embodiment, the liquid crystal layer may be a twisted nematic phase liquid crystal layer, and a long axis of the liquid crystal in a state where an electric field is applied to the liquid crystal layer may intersect with the transmission axis of the polarizer.

In an exemplary embodiment, the display device may further including: a light source disposed on an opposite surface of first insulating substrate, where light provided from the light source and transmitted through the first insulating substrate may be in an unpolarized state.

In embodiments of the display device according to the invention, a liquid crystal layer containing the dichroic dye may serve as an optical shutter, such that a problem of deterioration of the side visibility, which may occur at the time of vertical behavior of the liquid crystal, may be effectively prevented. In such an embodiment, one of polarizers typically provided in a display device, may be omitted, such that the thickness of the display panel and the manufacturing cost thereof may be reduced. In such an embodiment, a display device may have improved reliability, by interposing the polarizer between the two insulating substrates facing each other to effectively prevent the panel warpage problem caused by the moisture transmission or the like.

In such an embodiment, by achieving the color display using a wavelength conversion material that emits scattered light by converting the central wavelength of the incident light, the light efficiency and the side visibility are improved. In such an embodiment, even when the scattered light emitted by the wavelength conversion material enters the adjacent pixels, the dichroic dye in the liquid crystal layer may absorb at least some of the scattered light to minimize the defective color mixing.

In such an embodiment, because some of the light provided from the light source may be reflected to the light source side by disposing a reflective polarizer as a lower polarizer between the liquid crystal layer and the insulating substrate, the light efficiency is improved, and the brightness is also improved by reflecting the scattered light emitted by the wavelength conversion material to a viewer side.

Effects according to the embodiments of the invention are not limited by the contents illustrated above, and further various effects are included herein.

### BRIEF DESCRIPTION OF THE DRAWINGS

The above and other features of the invention will become more apparent by describing in detail exemplary embodiments thereof with reference to the attached drawings, in which:

FIG. 1 is a cross-sectional view of a display device according to an embodiment of the invention;

FIG. 2 is a diagram showing an optical axis of the display device of FIG. 1;

FIG. 3 is a cross-sectional view of a state in which the electric field is applied to a liquid crystal layer of the display device of FIG. 1;

FIG. 4 is a diagram for explaining an optical path and a polarization state of light in the display device of FIG. 3;

FIG. 5 is a cross-sectional view of a display device according to an alternative embodiment of the invention;

FIG. 6 is a cross-sectional view of a state in which the electric field is applied to the liquid crystal layer of the display device of FIG. 5;

FIG. 7 is a cross-sectional view of a display device according to another alternative embodiment of the invention;

FIG. 8 is a cross-sectional view of a state in which the electric field is applied to the liquid crystal layer of the display device of FIG. 7;

FIG. 9 is a cross-sectional view of a display device according to still another alternative embodiment of the invention;

FIG. 10 is a cross-sectional view of a state in which the electric field is applied to the liquid crystal layer of the display device of FIG. 9;

FIG. 11 is a cross-sectional view of a display device according to still another alternative embodiment of the invention;

FIG. 12 is a cross-sectional view of a state in which the electric field is applied to the liquid crystal layer of the display device of FIG. 11;

FIG. 13 is a diagram for explaining an optical axis of the display device according to still another alternative embodiment of the invention;

FIG. 14 is a cross-sectional view of a display device according to still another alternative embodiment of the invention; and

FIG. 15 is a result obtained by measuring the viewing angle characteristics and the contrast ratio in accordance with the experimental examples and comparative examples.

### DETAILED DESCRIPTION

Features of the invention and methods of accomplishing the same may be understood more readily by reference to the following detailed description of preferred embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other.

Like numbers refer to like elements throughout. “Or” means “and/or.” As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a,” “an” and “the” are intended to include the plural forms as well, including “at least one,” unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof “At least one” is not to be construed as limiting “a” or “an.” “Or” means “and/or.” As used herein, the term “and/or” includes any and all combinations of one or more of the associated listed items.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features.

Moreover, sharp angles that are illustrated may be rounded. Thus, the regions illustrated in the figures are schematic in nature and their shapes are not intended to illustrate the precise shape of a region and are not intended to limit the scope of the present claims.

In the specification, a first direction D1 refers to an arbitrary direction in a plane, a second direction D2 refers to a direction intersecting with the first direction D1 in the plane, and a third direction D3 refers to a direction orthogonal to the first and second directions D1 and D2 or the plane.

Hereinafter, embodiments of the invention will be described in detail referring to the accompanying drawings.

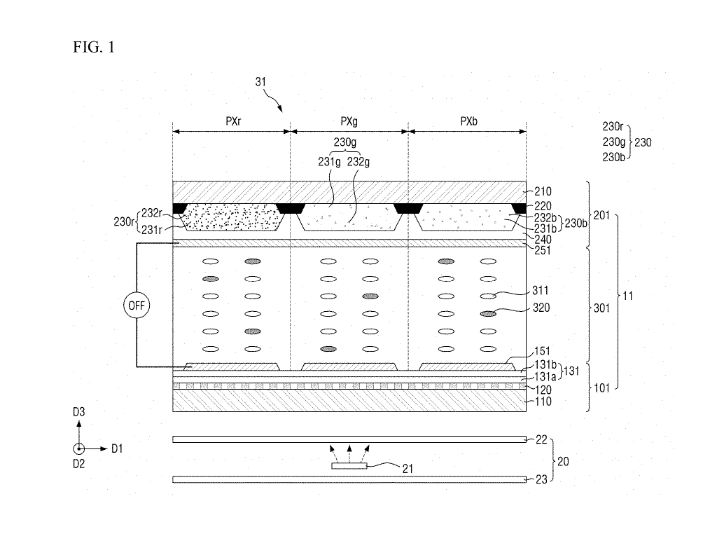

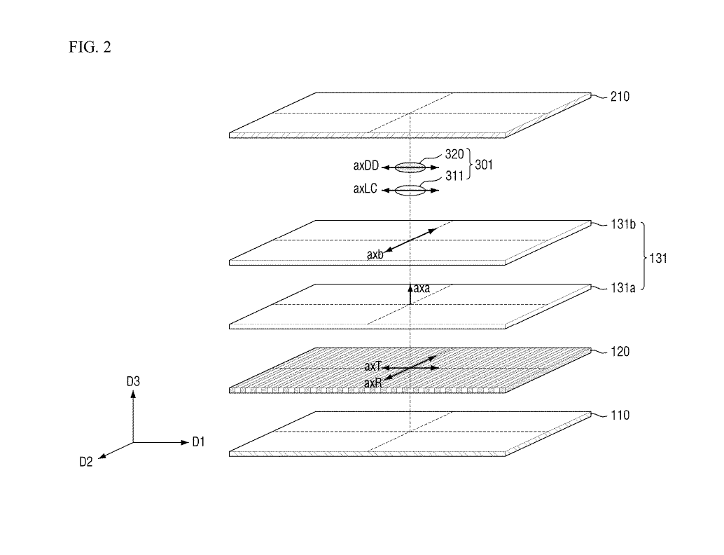

FIG. 1 is a cross-sectional view of a display device according to an embodiment of the invention. FIG. 2 is a diagram showing an optical axis of the display device of FIG. 1.

Referring to FIGS. 1 and 2, an exemplary embodiment of a display device 31 includes a display panel 11 and a light source assembly 20.

In an exemplary embodiment, a plurality of pixels is defined in the display panel 11. Each of the pixels may display one of the primary colors to achieve a color display. In one exemplary embodiment, for example, the plurality of pixels may include a first pixel PXr that displays a red image (e.g., a dot image), a second pixel PXg that displays a green image, and a third pixel PXb that displays a blue image. The first pixel PXr, the second pixel PXg and the third pixel PXb may define a single unit pixel for the color display and may be repeatedly disposed in the first direction D1 and the second direction D2 in the display panel 11. In an exemplary embodiment, the plurality of pixels may be arranged in an approximately matrix form when viewed from a plan view, e.g., a top plan view or a plan view in a thickness direction of the display panel 11.

The display panel 11 includes a first substrate 101, a second substrate 201 disposed opposite to, e.g., facing, the first substrate 101, and a liquid crystal layer 301 interposed between the first substrate 101 and the second substrate 201. In an exemplary embodiment, the light source assembly 20 is disposed outside of the first substrate 101 (on the lower side in FIG. 1), such that an image may be visible from—of the second substrate 201 (the upper side in FIG. 1).

The first substrate 101 includes a first insulating substrate 110, and a polarizing element (or polarizer) 120 disposed on the first insulating substrate 110, and may further include a phase difference layer 131 disposed on the polarizing element 120, and a first electrode 151 disposed on the phase difference layer 131.

The first insulating substrate 110 may be a transparent insulating substrate. In one exemplary embodiment, for example, the first insulating substrate 110 may be a glass substrate or a plastic substrate.

The polarizing element 120 is disposed on a first surface, e.g., an upper surface, of the first insulating substrate 110. The polarizing element 120 may include or be formed of organic or inorganic materials. In such an embodiment, the polarizing element 120 is inserted or disposed between the first insulating substrate 110 and the second insulating substrate 120, such that deformation of the polarizing element 120 caused by moisture or heat is effectively prevented, and the manufacturing cost is reduced.

In an exemplary embodiment, the polarizing element 120 may be a reflective polarizing element or a reflective polarizer. The reflective polarizing element may transmit polarization components parallel to a transmission axis axT and may reflect polarization components parallel to a reflection axis axR. In an exemplary embodiment, as shown in FIG. 2, the reflective polarizing element may be wire grid polarizer, but not being limited thereto. In an alternative exemplary embodiment, the reflective polarizing element may be a film type polarizer in which two layers with different refractive indexes in an in-plane uniaxial direction are repeatedly and alternately stacked.

In an exemplary embodiment, where the polarizing element 120 is a wire grid polarizer, the polarizing element 120 includes a plurality of line grids which extends in the second direction D2 and is repeatedly disposed by being spaced apart from each other in the first direction D1. In such an embodiment, a plurality of line grids may be disposed parallel to the second direction D2, and spaced apart from each other in the first direction D1 with a constant pitch or gap. The transmission axis axT of the polarizing element 120 is approximately parallel to the first direction D1, and the reflection axis axR may be approximately parallel to the second direction D2. The light transmitted through the polarizing element 120 may have only the polarization component in the first direction D1. The line grid may include aluminum (Al), silver (Ag), copper (Cu) and/or nickel (Ni). Although it is not illustrated in the drawings, a protective layer (not illustrated) including or be formed of organic or inorganic materials may be further disposed between the polarizing element 120 and the phase difference layer 131.

The phase difference layer 131 may be disposed on the polarizing element 120. The phase difference layer 131 may be a birefringence layer having one or more optical axes and may be a phase retardation layer which changes the polarization state of light transmitting through the phase difference layer 131. In an exemplary embodiment, the phase difference layer 131 may include a first phase difference layer 131a as a uniaxial phase difference layer that is disposed on the polarizing element 120 and satisfies the following relationship: n_{z}≠nₓ=n_{y}, and a second phase difference layer 131b as a uniaxial phase difference layer that is disposed on the first phase difference layer 131a and satisfies the following relationship: nₓ≠n_{y}=n_{z}. Herein, nₓ denotes an in-plane x-axis direction refractive index of an arbitrary x-y-z coordinate system, n_{y} denotes a refractive index in the in-plane y-axis direction, and n_{z} denotes a refractive index in the z-axis direction, i.e., in the thickness direction of the display panel 11.

In one exemplary embodiment, for example, the first phase difference layer 131a may be a positive type uniaxial phase difference layer that satisfies following relationship: n_{z}>nₓ=n_{y}, and the second phase difference layer 131b may be a negative type uniaxial phase difference layer which satisfies following relationship: nₓ<n_{y}=n_{z}. The phase difference value Rₜₕ of the first phase difference layer 131a in the thickness direction may be in a range of about 80 nanometers (nm) to about 120 nm, e.g., about 100 nm, the in-plane phase difference value Rₒ of the second phase difference layer 131b may be in a range of about 80 nanometers (nm) to about 150 nm, e.g., about 120 nm, and the phase difference value of the second phase difference layer 131b in the thickness direction may be in a range of about 80 nm to about 150 nm, e.g., about 120 nm.

In an exemplary embodiment, a ground axis of the phase difference layer 131 may be parallel to the reflection axis axR of the polarizing element 120. Herein, the ground axis refers to an optical axis having highest refractive index in the in-plane direction. When the phase difference layer 131 includes a first phase difference layer 131a that has no difference in refractive index in the in-plane direction and has an optical axis axa in the thickness direction, and a second phase difference layer 131b that has a difference in refractive index in the in-plane direction, the ground axis of the phase difference layer 131 refers to the ground axis axb of the second phase difference layer 131b.

Among the light transmitting through the phase difference layer 131, light transmitting in the direction (e.g., the third direction) perpendicular to the display panel 11 maintains the line polarization state when transmitted through the polarizing element 120, and light transmitting in the direction oblique to the display panel 11a is converted into circularly polarized light or elliptically polarized light when transmitted through the polarizing element 120. Accordingly, deterioration of side visibility caused by misalignment of the transmission axis of the liquid crystal layer 301 and the transmission axis axT of the polarizing element 120, which serve as a light shutter, when viewed from a side of the display device 31, is effectively reduced.

In an alternative exemplary embodiment, the first phase difference layer 131a is a negative type uniaxial phase difference layer which satisfies the following relationship: n_{z}<nₓ=n_{y}, and the second phase difference layer 131b is a positive type uniaxial phase difference layer which satisfies the following relationship: nₓ>n_{y}=n_{z}. In another alternative exemplary embodiment, the first phase difference layer 131a may be a uniaxial phase difference layer which satisfies the following relationship: n_{z}≠nₓ=n_{y}, and the second phase difference layer 131b may be a biaxial phase difference layer which satisfies the following relationship: nₓ≠n_{y}≠n_{z}. Although it is not illustrated in the drawings, a predetermined additional layer may be further disposed between the first phase difference layer 131a and the second phase difference layer 131b.

In an exemplary embodiment, as shown in FIG. 1, a plurality of first electrodes 151 may be disposed on the phase difference layer 131. Each of the first electrodes 151 may be a pixel electrode which is disposed for each of the pixels PXr, PXg and PXb and to which data voltage is applied. The first electrode 151 may include or be formed of a transparent conductive material. In one exemplary embodiment, for example, the first electrode 151 may include or be formed of, but not limited to, indium tin oxide, indium zinc oxide, zinc oxide or the like.

Although not illustrated in the drawings, a wiring layer including gate lines and data lines for transmitting the driving signal, a switching element, an insulating layer and the like may be further disposed between the first insulating substrate 110 and the first electrode 151. Various configurations and structures associated therewith are known in the art, and the detailed description thereof will be omitted.

Next, the second substrate 201 will be described. In an exemplary embodiment, the second substrate 201 may include a second insulating substrate 210, a light-shielding member 220 and a wavelength tuning layer 230, which are disposed on a surface (e.g., a lower surface) of the insulating substrate 210 facing the first substrate 101, a planarization layer 240 disposed on the wavelength tuning layer 230, and a second electrode 251 disposed on the planarization layer 240.

The second insulating substrate 210 may be a transparent insulating substrate similar to the first insulating substrate 110. The light-shielding member 220 is disposed on a surface of the second insulating substrate 210 or between the second insulating substrate 210 and the second electrode 251. The light-shielding member 220 may include a material that absorbs or reflects light of a particular wavelength band to block the transmission of light, i.e., a light-shielding material. In one exemplary embodiment, for example, the light-shielding member 220 may be a black matrix. The light-shielding member 220 is disposed at or to cover a boundary of each of the pixels PXr, PXg and PXb to define a light transmission region in which each of the pixels PXr, PXg and PXb is at least partially exposed.

The wavelength tuning layer 230 may be disposed on the surface of the second insulating substrate 210 or between the second insulating substrate 210 and the second electrode 251. In an exemplary embodiment, the wavelength tuning layer 230 is disposed to overlap the light transmission region and may at least partially overlap the light-shielding member 220.

The wavelength tuning layer 230 may maintain or convert the wavelength of the emitted light or the light transmitted thereto and passed therethrough. In an exemplary embodiment, the wavelength tuning layer 230 may include a first wavelength conversion layer 230r disposed on the first pixel PXr, and a second wavelength conversion layer 230g disposed on the second pixel PXg, and may further include a light transmitting layer 230b disposed on the third pixel PXb.

In an exemplary embodiment, the first wavelength conversion layer 230r may include a first light transmitting resin 231r, and a first wavelength conversion material 232r, which is dispersed in the first light transmitting resin 231r to convert or shift a central wavelength of the incident light into a first color wavelength. In such an embodiment, the second wavelength conversion layer 230g may include a second light transmitting resin 231g, and a second wavelength conversion material 232g, which is dispersed in the second light transmitting resin 231g to convert or shift the central wavelength of the incident light into a second color wavelength. In such an embodiment, the light transmitting layer 230b may include a third light transmitting resin 231b, and a light scattering material 232b, which is dispersed in the third light transmitting resin 231b, to scatter and emit the incident light. In an exemplary embodiment, the first color may be red, and the second color may be green. Hereinafter, for convenience of description, an exemplary embodiment, where the first color is red, and the second color is green, will be described in detail.

In such an embodiment, each of the first light transmitting resin 231r, the second light transmitting resin 231g and the third light transmitting resin 231b may include or be formed of a transparent material which transmits the incident light without converting the wavelength thereof. The first to third light transmitting resins 231r, 231g and 231b may include a same material as each other or different materials from each other.

Each of the first wavelength conversion material 232r and the second wavelength conversion material 232g may include a quantum dot, a quantum rod or a phosphor material. The first and second wavelength conversion materials 232r and 232g may absorb the incident light and emit light having a central wavelength different from that of the incident light. In an exemplary embodiment, each of the first and second wavelength conversion materials 232r and 232g may scatter and emit the light incident on the first pixel PXr and the second pixel PXg in multiple or various directions regardless of the incident angle. In an exemplary embodiment, the emitted light may be in an unpolarized state in which the polarization is eliminated. Herein, the unpolarized light refers to light which is not consist of only a single polarization component in a specific direction, i.e., light that is not polarized only in a particular direction, but light having randomized polarization components. The unpolarized light may include natural light, for example.

In an exemplary embodiment, an average particle size of the first wavelength conversion material 232r for converting the central wavelength of the incident light into the red wavelength may be larger than an average particle size of the second wavelength conversion material 232g for converting the central wavelength of the incident light into the green wavelength. The first and second wavelength conversion materials 232r and 232g may include a same material as each other or different materials from each other.

The light scattering particle 232b may scatter and emit the light incident on the third pixel PXb in multiple directions regardless of the incident angle. In such an embodiment, the emitted light may be in an unpolarized state in which the polarization is eliminated. In such an embodiment, the light transmitting through the third pixel PXb as well as the first and second pixels PXr and PXg is set as the scattered light, the similar light emission characteristics are provided for each pixel, thereby improving the side visibility.

The light scattering particle 232b may be a material having a refractive index different from the third transmitting resin 231b. In one exemplary embodiment, for example, the light scattering particle 232b may be an organic particle or an inorganic particle, an organic and inorganic composite particle or a particle having a hollow structure. In one exemplary embodiment, for example, the organic particle may include acrylic resin particles or urethane resin particles. In one exemplary embodiment, for example, the inorganic particle may include metal oxide particles such as titanium oxide.

In an alternative exemplary embodiment, one or more of the first wavelength conversion layer 230r, the second wavelength conversion layer 230g and the light transmitting layer 230b may be omitted. In another alternative exemplary embodiment, the third wavelength conversion layer 230b may include a third light transmitting resin, and a third wavelength conversion material that is dispersed in the third transmitting resin to convert or shift the central wavelength of the incident light into a third color wavelength.

In an exemplary embodiment, a planarization layer 240 may be disposed on the wavelength tuning layer 230. The planarization layer 240 may include or be formed of an organic material. When the thicknesses of the first wavelength conversion layer 230r, the second wavelength conversion layer 230g and the light transmitting layer 230b are different from one another, the planarization layer 240 may compensate the height difference of the components stacked on the surface of the second insulating substrate 210 to be uniform. Alternatively, the planarization layer 240 may be omitted.

In an exemplary embodiment, the second electrode 251 may be disposed on the planarization layer 240. The second electrode 251 may be a common electrode to which a common voltage is applied, and be commonly provided for all of the pixels. The second electrode 251 may be integrally formed as a single unitary and indivisible unit. The second electrode 251 may include or be formed of a transparent conductive material similar to the first electrode 151. In one exemplary embodiment, for example, the second electrode 251 may include or be formed of, but not limited to, indium tin oxide, indium zinc oxide, zinc oxide or the like.

The liquid crystal layer 301 will hereinafter be described in detail. The liquid crystal layer 301 includes a liquid crystal 311 as a host material, and a dichroic dye 320 as a guest material.

In an exemplary embodiment, the liquid crystal 311 may be liquid crystal which has positive dielectric constant anisotropy and is substantially horizontally aligned in an initial alignment state in which no electric field is applied to the liquid crystal layer 301. In such an embodiment, an azimuth formed by a director axLC of a long axis (or longitudinal axis) of the liquid crystal 311 on the plane in the initial alignment state may be disposed substantially in parallel to the first direction D1 to maintain a stabilized state. In an alternative exemplary embodiment, the liquid crystal 311 may have a predetermined line inclination angle.

The dichroic dye 320 may be uniformly mixed in the liquid crystal layer 301 to absorb light of a particular wavelength. In one exemplary embodiment, for example, the dichroic dye 320 may be a dye that has a long axis and a short axis (or a transverse axis), and absorbs the polarization component parallel to the long axis. In one exemplary embodiment, for example, the dichroic dye 320 may include azo-based dye, anthraquinone-based dye, coumarin-based dye, perylene-based dye, merocyanine-based dye, indigo-based dye, a polythiophene-based dye or the like. In an exemplary embodiment, where the light source 21 provides blue light, yellow dye having high absorption of blue wavelength may be used as the dichroic dye 320.

The director axLC of the long axis of the liquid crystal 311 and the director axDD of the long axis of the dichroic dye 320 may be approximately match by geometrical molecular structures of the liquid crystal 311 and the dichroic dye 320. Thus, the azimuth formed by the director axDD of the long axis of the dichroic dye 320 in a state where no electric field is applied to the liquid crystal layer 301 may be arranged approximately in parallel with the first direction D1 to maintain a stabilized state. In such an embodiment, the polarization direction of light transmitted through the polarizing element 120 matches the long axis direction of the dichroic dye 320 when no electric field is applied to the liquid crystal layer 301. Accordingly, a relatively large quantity of light provided from the light source 21 is absorbed by the dichroic dye 320, and a relatively small quantity of light may reach the wavelength tuning layer 230. That is, when the light absorption rate of the dichroic dye 320 is sufficient, even when there is no separate polarizing element on the upper side of the liquid crystal layer 301, the light may be effectively shut off in accordance with a voltage applied to the liquid crystal layer 301.

In such an embodiment, as long as the light provided from the light source 21 is effectively absorbed, the concentration of the dichroic dye 320 in the liquid crystal layer 301 is not particularly limited. In one exemplary embodiment, for example, the dichroic dye 320 may be mixed in a proportion of about 0.1 weight percent (wt %) to about 15 wt % to the liquid crystal 311.

The light source assembly 20 may include a light source 21, an optical member 22 and a reflecting member 23. In an exemplary embodiment, the light source 21 may be an LED light source, an OLED light source, a fluorescent lamp light source or the like. The light source 21 may emit light of a particular wavelength to the display panel 11 side. In an exemplary embodiment, the light source 21 may provide light having a single central wavelength that is shorter than the central wavelength of red and the central wavelength of green. In one exemplary embodiment, for example, the light source 21 may be a light source which provides blue light having the central wavelength in a range of about 400 nm to about 500 nm. In an alternative exemplary embodiment, the light source 21 may provide light of ultraviolet wavelength. In such an embodiment, a third wavelength conversion material which converts the central wavelength of the incident light into the blue wavelength may be disposed on the pixel for displaying blue, instead of the light scattering material.

In an exemplary embodiment, as shown in FIG. 1, the optical member 22 is disposed between the light source 21 and the display panel 11. The optical member 22 may include a diffusion sheet, a prism sheet, a lens sheet or the like, and may modulate the properties and the path of light provided by the light source 21. Alternatively, the optical member 22 may be omitted. The reflecting member 23 may be disposed below the light source 21. The reflecting member 23 may re-reflect the light that is emitted to the lower side from the light source 21 or is reflected downward by the polarizing element 120 or the like, and may provide such light back to the display panel 11. Accordingly, the light efficiency of the display device may be improved. Various configurations and structures associated with the light source assembly 20 are known in the art, and any detailed description thereof will be omitted.

Hereinafter, the operation of the display device according to an embodiment of the invention will be described in detail.

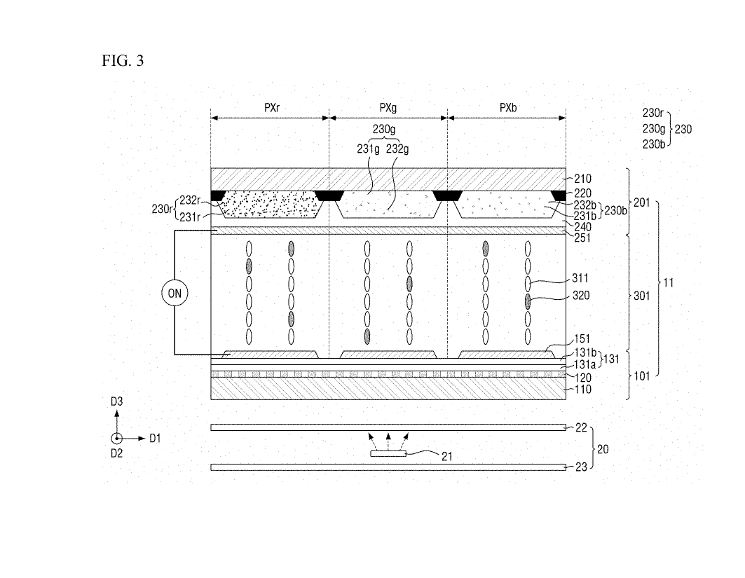

FIG. 3 is a cross-sectional view of a state in which the electric field is applied to the liquid crystal layer of the display device of FIG. 1.

Referring to FIG. 3, when different voltages are provided to the first electrode 151 and the second electrode 251 and the vertical electric field is thereby applied to the liquid crystal layer 301, the liquid crystal 311 having the positive dielectric constant anisotropy may be rearranged so that its long axis is substantially parallel to the electric field direction. Furthermore, the dichroic dye 320 may also be rearranged so that its director matches the liquid crystal 311 in accordance with rearrangement of the liquid crystal 311. In such an embodiment, the polarization direction D1 of light transmitted through the polarizing element 120 intersects with the long axis direction D3 of the dichroic dye 320 when the vertical electric field is applied to the liquid crystal layer 301. Therefore, a relatively small quantity of light provided from the light source 21 is absorbed by the dichroic dye 320, and a relatively large quantity of light may reach the wavelength tuning layer 230 to contribute to the color display.

In such an embodiment, as mentioned above, since the liquid crystal layer 301 containing the dichroic dye 320 may serve as a light shutter, at least one of two polarization elements conventionally provided in a liquid crystal display device may be omitted. In such an embodiment, where the polarizing element is omitted, the thickness of the display device 31 may be reduced and the manufacturing cost thereof may be reduced. In such an embodiment, since the liquid crystal layer 301 changes the polarization state and also absorbs light of a particular polarization state, despite the vertical behavior of the liquid crystal 311, deterioration of side visibility may be effectively prevented. In such an embodiment, since the distance between the liquid crystal layer 301 serving as a light shutter and the wavelength tuning layer 230 disposed on the upper part thereof may be minimized, the defective color mixture such as leakage of light to adjacent pixels may be effectively prevented.

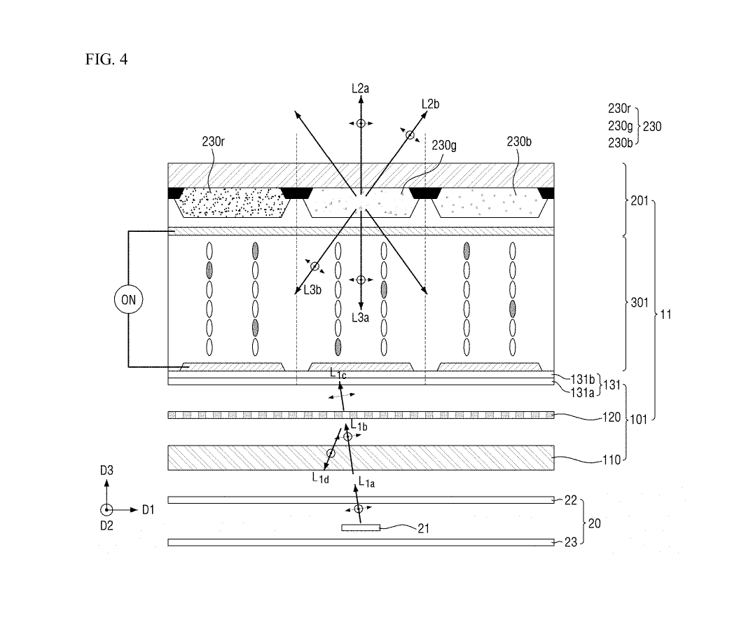

FIG. 4 is a diagram for explaining the optical path and the polarization state of light in the display device of FIG. 3.

Referring to FIG. 4, unpolarized light L₁ₐ from the light source 21 is provided to the display panel 11 by transmitting through the optical member 22. In such an embodiment, no polarizing element is disposed between the display panel 11 and the light source 21. Therefore, the light L_{1b} that transmits or is transmitted through the first insulating substrate 110 may be still in an unpolarized state.

When the unpolarized light L_{1b} transmitted through the first insulating substrate 110 reaches the polarizing element 120, light L_{1c} of a polarization component parallel to the transmission axis (e.g., first direction) of the polarizing element 120 transmits through the polarizing element 120, and light L_{1d} of a polarization component parallel to the reflection axis (e.g., second direction) of the polarizing element 120 may be reflected by the polarization element 120. The light L_{1c} transmitted through the polarizing element 120 reaches the wavelength tuning layer 230 to contribute to the color display of the display device, and the light L_{1d} reflected by the polarization element 120 may be retro-reflected by the lower light source assembly 20.

In such an embodiment, the first and second wavelength conversion materials and the light scattering particles within the wavelength tuning layer 230 may emit light in the unpolarized state which is scattered in multiple directions, regardless of the incident angle of the incident light.

In one exemplary embodiment, for example, among the light emitted to the outside of the display panel 11 (the upper side of FIG. 4) by the second wavelength conversion layer 230g, light L₂ₐ emitted in a direction (e.g., a third direction) perpendicular to the display panel 11 is visible in green from the front of the display device, and light L_{2b} emitted in a direction oblique to the display panel 11 may be visible in green from the side of the display device.

In such an embodiment, among the light emitted to the inside of the display panel 11 (the lower side of FIG. 4) by the second wavelength conversion layer 230g, light L₃ₐ emitted in a direction perpendicular to the display panel 11 may be at least partially reflected by the polarizing element 120 after transmitted through the liquid crystal layer 301 and the phase difference layer 131 in which the transmission axes change depending on the applied voltage. In such an embodiment, the light reflected by the polarization element 120 may contribute to the color display of the display device.

In such an embodiment, among the light emitted to the inside of the display panel 11 by the second wavelength conversion layer 230g, at least some of the light L_{3b} emitted in a direction oblique to the display panel 11 are absorbed by the liquid crystal layer 301 in which the absorption axis changes depending on the applied voltage, thereby effectively preventing the light L_{3b} emitted in the direction oblique to the display panel 11 from entering the adjacent pixels which may cause defective color mixture.

Hereinafter, the display device according to alternative exemplary embodiments of the invention will be described. However, for convenience of description, any repetitive description of substantially the same configuration as the embodiments of the display device described above will be simplified or omitted. The same or like elements shown in FIGS. 4 to 14 have been labeled with the same reference characters as used above to describe the exemplary embodiments of the display device shown in FIG. 1.

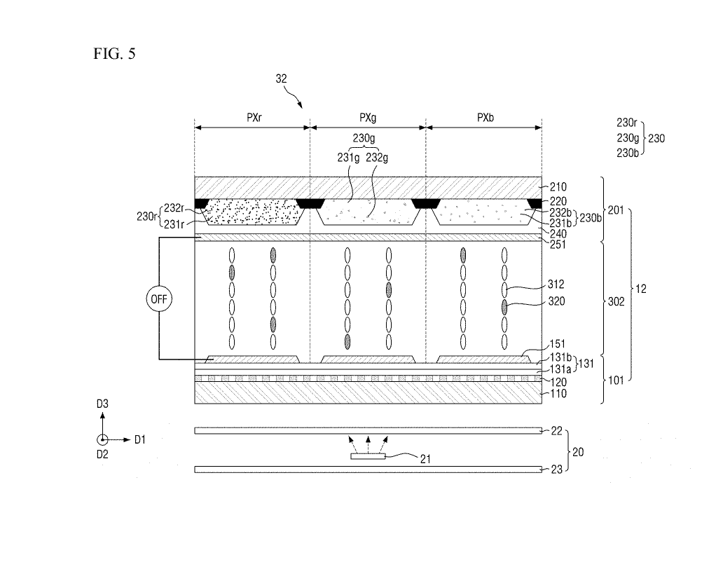

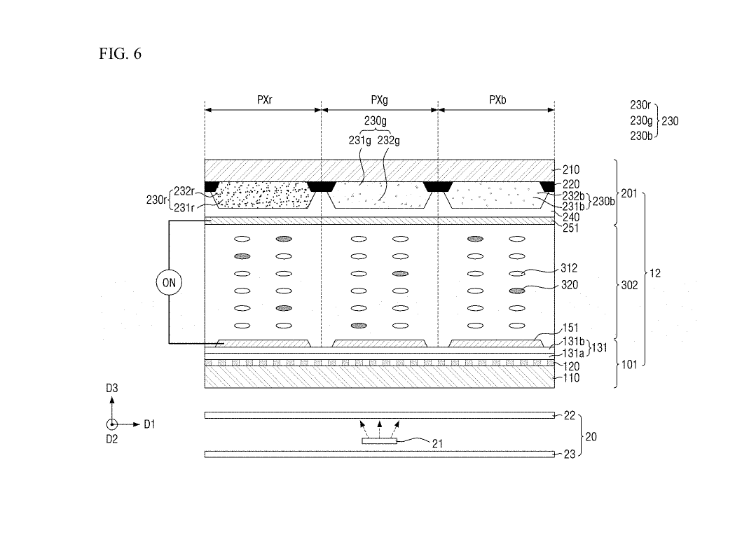

FIG. 5 is a cross-sectional view of a display device according to an alternative exemplary embodiment of the invention. FIG. 6 is a cross-sectional view of a state in which the electric field is applied to the liquid crystal layer of the display device of FIG. 5.

In such an embodiment, referring to FIG. 5, a liquid crystal 312 of a display device 32 is different from that of an exemplary embodiment of the display device 31 described above with reference to FIG. 1 in that the liquid crystal 312 has negative dielectric constant anisotropy and is substantially vertically aligned in an initial alignment state in which no electric field is applied to the liquid crystal layer 302.

In such an embodiment, since the director of the long axis of the liquid crystal 312 in the initial alignment state is arranged to face in a direction (e.g., a third direction) approximately normal to the orientation surface, a stabilized state may be maintain. Alternatively, the liquid crystal 312 may have a predetermined line inclination angle.

The director of the long axis of the liquid crystal 312 and the director of the long axis of the dichroic dye 320 may approximately match with each other. Accordingly, since the director of the long axis of the dichroic dye 320 is disposed approximately in the third direction D3 in a state in which no electric field is applied to the liquid crystal layer 302, a stabilized state may be maintained. In such an embodiment, the polarization direction D1 of light transmitted through the polarizing element 120 intersects with the long axis direction D3 of the dichroic dye 320 when no electric field is applied to the liquid crystal layer 302. Therefore, a relatively small quantity of light provided from the light source 21 is absorbed by the dichroic dye 320, and a relatively large quantity of light may reach the wavelength tuning layer 230 to contribute to the color display.

In such an embodiment, referring to FIG. 6, when different voltages are provided to the first electrode 151 and the second electrode 251, and the vertical electric field is thereby applied to the liquid crystal layer 302, the liquid crystal 312 having negative dielectric constant anisotropy may be rearranged in a way such that its long axis is approximately perpendicular to the direction of the electric field. Specifically, in a state in which the electric field is applied to the liquid crystal layer 302, the azimuth formed by the director of the long axis of the liquid crystal 312 on the plane may be rearranged to be approximately parallel to the first direction D1. Furthermore, in accordance with the rearrangement of the liquid crystal 312, the dichroic dye 320 may also be rearranged in a way such that the director is aligned with the liquid crystal 312. In such an embodiment, the polarization direction of light transmitted through the polarizing element 120 matches the long axis direction of the dichroic dye 320 when the electric field is applied to the liquid crystal layer 30. Accordingly, a relatively large quantity of light provided from the light source 21 is absorbed by the dichroic dye 320, and a relatively small quantity of light may reach the wavelength tuning layer 230.

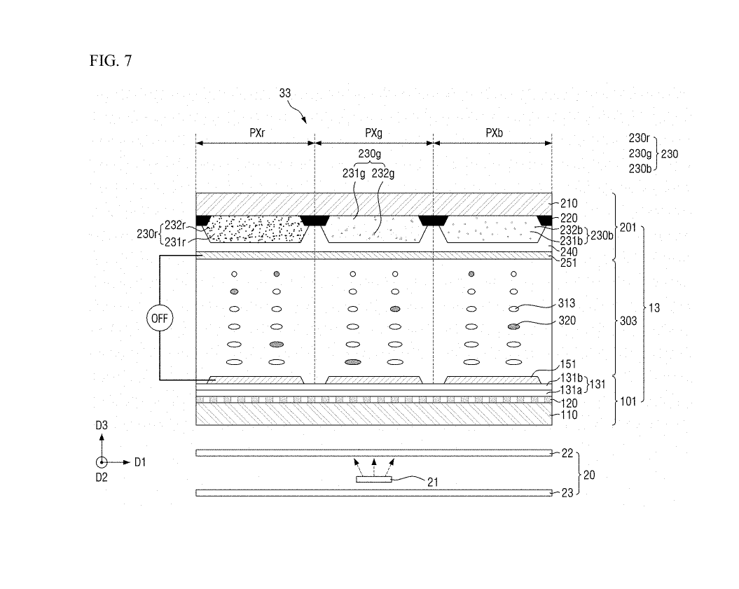

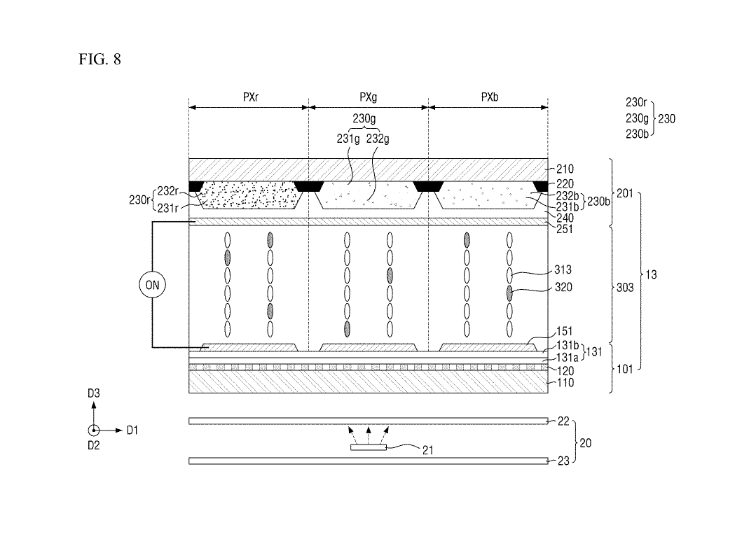

FIG. 7 is a cross-sectional view of a display device according to another alternative embodiment of the invention. FIG. 8 is a cross-sectional view of a state in which the electric field is applied to the liquid crystal layer of the display device of FIG. 7.

In such an embodiment, referring to FIG. 7, the liquid crystal layer 303 of the display device 33 is different from an exemplary embodiment of the display device 31 described above with reference to FIG. 1 in that the liquid crystal layer 303 is a twisted nematic phase liquid crystal layer that includes a liquid crystal 313 having the positive dielectric constant anisotropy.

In such an embodiment, in the initial alignment state in which no electric field is applied to the liquid crystal layer 303, the liquid crystal 313 is substantially horizontally orientated, and the long axes of the liquid crystals 313 in the liquid crystal layer 303 may be arranged in a gradually twisted state depending on the position in the thickness direction (the third direction). FIG. 7 illustrates an embodiment where the long axis of the liquid crystal adjacent to the first substrate 101 and the long axis of the liquid crystal adjacent to the second substrate 201 are twisted at approximately 90°, but not being limited thereto. Alternatively, the twist angle may be approximately 180°, approximately 270° or approximately 360° or more.

The dichroic dye 320 as a guest material may have an arrangement state similar to the liquid crystal 313 without impeding the alignment of the liquid crystal 313, by the geometrical molecular structures of the liquid crystal 313 and the dichroic dye 320. That is, in a state in which no electric field is applied to the liquid crystal layer 303, the dichroic dye 320 is arranged in the same manner as the liquid crystal 313 having the gradually twisted arrangement in the thickness direction D3 and may maintain a stabilized state. In such an embodiment, when no electric field is applied to the liquid crystal layer 303, the optical axis of the polarized light transmitted through the polarizing element 120 may rotate along the director of the liquid crystal 313 twisted in the thickness direction D3, and furthermore, the optical axis of the rotated polarized light matches the long axis direction of the dichroic dye 320 having the twisted arrangement similar to the liquid crystal 313. Accordingly, a relatively large quantity of light provided from the light source 21 is absorbed by the dichroic dye 320, and a relatively small quantity of light may reach the wavelength tuning layer 230.

In such an embodiment, referring to FIG. 8, when different voltages are provided to the first electrode 151 and the second electrode 251 and the vertical electric field is thereby applied to the liquid crystal layer 303, the liquid crystal 313 having the positive dielectric constant anisotropy may be rearranged in a way such that its long axis is substantially parallel to the electric field direction. More specifically, the direction D3 of the long axis of the liquid crystal 313 may be rearranged to intersect with the transmission axis direction D1 of the polarizing element 120 in a state in which the electric field is applied to the liquid crystal layer 303. Furthermore, the dichroic dye 320 may also be rearranged in a way such that the director matches the liquid crystal 313 in accordance with the rearrangement of the liquid crystal 313. In such an embodiment, the polarization direction D1 of light transmitted through the polarizing element 120 intersects with the long axis direction D3 of the dichroic dye 320 when the electric field is applied to the liquid crystal layer 303. Therefore, a relatively small quantity of light provided from the light source 21 is absorbed by the dichroic dye 320, and a relatively large quantity of light may reach the wavelength tuning layer 230 to contribute to the color display.

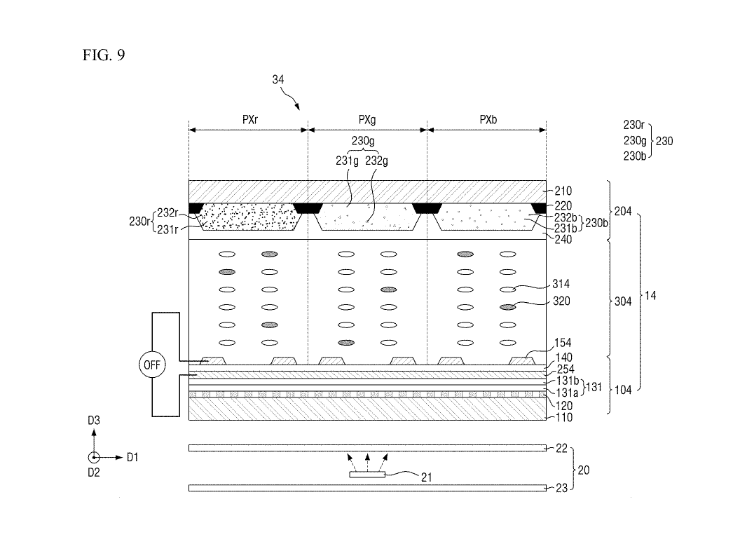

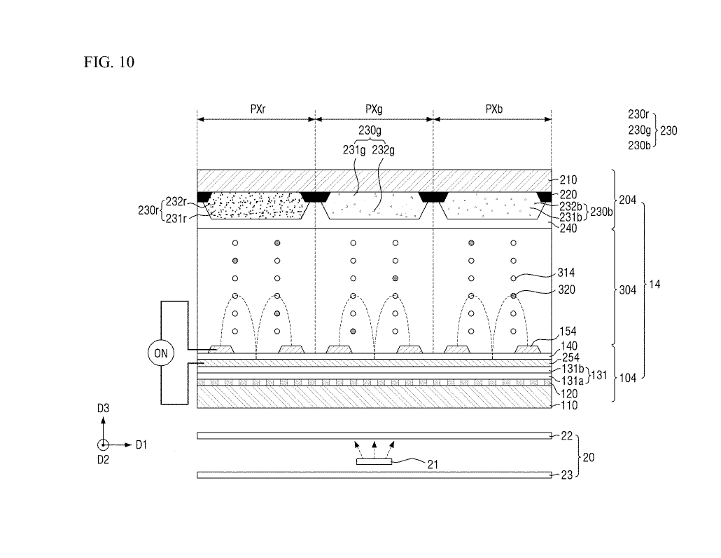

FIG. 9 is a cross-sectional view of a display device according to still another alternative embodiment of the invention. FIG. 10 is a cross-sectional view of a state in which the electric field is applied to the liquid crystal layer of the display device of FIG. 9.

In such an embodiment, referring to FIG. 9, a second electrode 254 of a display device 34 is different from the display device 31 of FIG. 1 in that the second electrode 254 is disposed in the first substrate 104 rather than being disposed in the second substrate 204, and the liquid crystal 314 has negative dielectric constant anisotropy.

In such an embodiment, as shown in FIG. 9, the second electrode 254 may be disposed on the phase difference layer 131. An interlayer insulating film 140 is disposed on the second electrode 254, and the first electrode 154 may be disposed on the interlayer insulating film 140 to be insulated from the second electrode 254. The first electrode 154 includes a plurality of adjacent branch electrodes and may have a slit therebetween. In an exemplary embodiment, an extending direction of the slit may be approximately the second direction D2, but is not limited thereto. In such an embodiment, as shown in FIG. 10, vertical electric field and horizontal electric field may be effectively generated among the second electrode 254 located in the slit and the branch electrodes of the first electrodes 154 located on both sides of the second electrode 254.

In such an embodiment, in an initial alignment state in which no electric field is applied to the liquid crystal layer 304, the azimuth formed by the director of the long axis of the liquid crystal 314 on the plane is arranged to be approximately parallel to the first direction D1 as shown in FIG. 9 and may maintain a stabilized state.

The director of the long axis of the liquid crystal 314 and the director of the long axis of the dichroic dye 320 may approximately match with each other. Accordingly, in a state in which no electric field is applied to the liquid crystal layer 304, the director of the long axis of the dichroic dyes 320 is arranged to face approximately the first direction D1 and may maintain a stabilized state. In such an embodiment, the polarization direction of light transmitted through the polarizing element 120 matches the long axis direction of the dichroic dye 320 when no electric field is applied to the liquid crystal layer 304. Accordingly, a relatively many amount of light provided from the light source 21 is absorbed by the dichroic dye 320, and a relatively small quantity of light may reach the wavelength tuning layer 230.

In such an embodiment, referring to FIG. 10, when different voltages are provided to the first electrode 154 and the second electrode 254, and the vertical electric field and the horizontal electric field are thereby applied to the liquid crystal layer 304, the liquid crystal 314 having negative dielectric constant anisotropy may be rearranged in the plane so that its long axis is approximately perpendicular to the direction of the electric field. In such an embodiment, in accordance with the rearrangement of the liquid crystal 314, the dichroic dye 320 may also be rearranged in a way such that the director matches the liquid crystal 314. In such an embodiment, the polarization direction D1 of light transmitted through the polarizing element 120 intersects with the long axis direction D2 of the dichroic dye 320 when the vertical electric field and the horizontal electric field are thereby applied to the liquid crystal layer 304. Therefore, a relatively small quantity of light provided from the light source 21 is absorbed by the dichroic dye 320, and a relatively large quantity of light may reach the wavelength tuning layer 230 to contribute to the color display.

Alternatively, the transmission axis of the polarizing element 120 may be approximately parallel to the second direction D2. Alternatively, the liquid crystal layer 304 may be a twisted nematic phase liquid crystal layer.

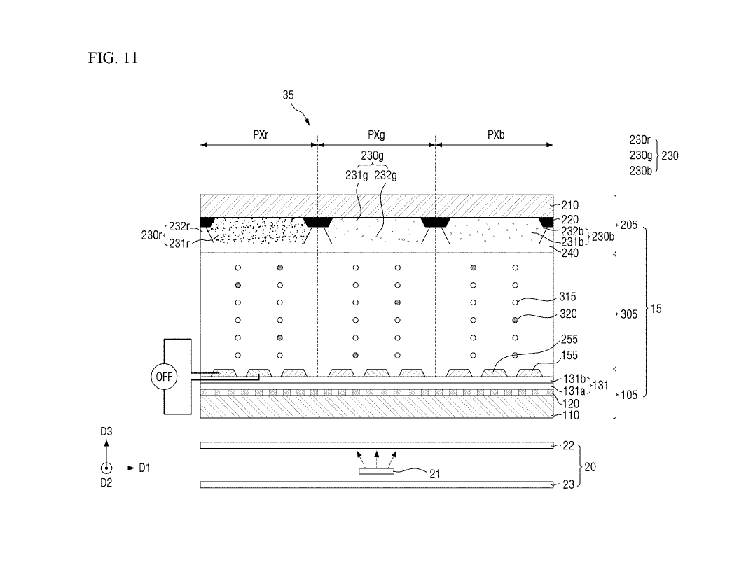

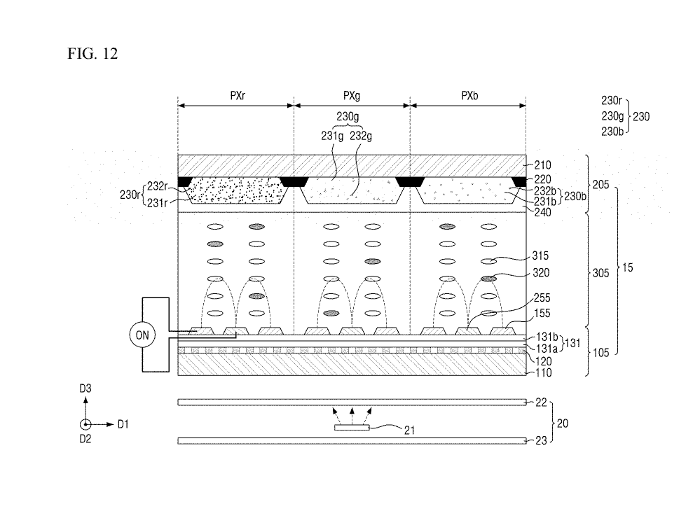

FIG. 11 is a cross-sectional view of a display device according to another alternative embodiment of the invention. FIG. 12 is a cross-sectional view of a state in which the electric field is applied to the liquid crystal layer of the display device of FIG. 11.

Referring to FIG. 11, such an embodiment of the display device 35 differs from an exemplary embodiment of the display device 34 described above with reference to FIG. 9 in that a second electrode 255 is disposed on the same layer as the first electrode 155, the liquid crystal 315 has positive dielectric constant anisotropy, and the azimuth formed by the director of the long axis of the liquid crystal 315 on the plane in the initial alignment state in which no electric field is applied to the liquid crystal layer 305 is arranged to be approximately parallel to the second direction D2 to maintain a stabilized state.

In such an embodiment, as shown in FIG. 11, the first electrode 155 and the second electrode 255 may be disposed on the phase difference layer 131 to be spaced apart from each other. The first electrode 155 and the second electrode 255 may be alternately disposed, and a slit may be provided between the first electrode 155 and the second electrode 255 adjacent to each other. The extending direction of the slit may be approximately the second direction D2, but is not limited thereto. In such an embodiment, a horizontal electric field may be generated between the first electrode 155 and the second electrode 255 adjacent to each other.

In such an embodiment, the director of the long axis of the liquid crystal 315 and the director of the long axis of the dichroic dye 320 may approximately match. Accordingly, in a state in which no electric field is applied to the liquid crystal layer 305, since the director of the long axis of the dichroic dye 320 is arranged to face approximately the second direction D2, a stabilized state may be maintained. In such an embodiment, the polarization direction D1 of light transmitted through the polarizing element 120 intersects with the long axis direction D2 of the dichroic dye 320 when no electric field is applied to the liquid crystal layer 305. Therefore, a relatively small quantity of light provided from the light source 21 is absorbed by the dichroic dye 320, and a relatively large quantity of light may reach the wavelength tuning layer 230 to contribute to the color display.

In such an embodiment, referring to FIG. 12, when different voltages are provided to the first electrode 155 and the second electrode 255, and the horizontal electric field is thereby applied to the liquid crystal layer 305, the liquid crystal 315 having positive dielectric constant anisotropy may be rearranged so that its long axis is substantially parallel to the electric field direction. Specifically, in a state in which the electric field is applied to the liquid crystal layer 305, the azimuth formed by the director of the long axis of the liquid crystal 315 on the plane may be rearranged to be approximately parallel to the first direction D1. Furthermore, in accordance with the rearrangement of the liquid crystal 315, the dichroic dye 320 may be rearranged in a way such that the director matches the liquid crystal 315. In such an embodiment, the polarization direction of light transmitted through the polarizing element 120 matches the long axis direction of the dichroic dye 320 when the electric field is applied to the liquid crystal layer 305. Accordingly, a relatively large quantity of light provided from the light source 21 is absorbed by the dichroic dye 320, and a relatively small quantity of light may reach the wavelength tuning layer 230.

In another alternative exemplary embodiment, the transmission axis of the polarizing element 120 may be approximately parallel to the second direction D2. In still another alternative embodiment, the liquid crystal layer 305 may be a twisted nematic phase liquid crystal layer.

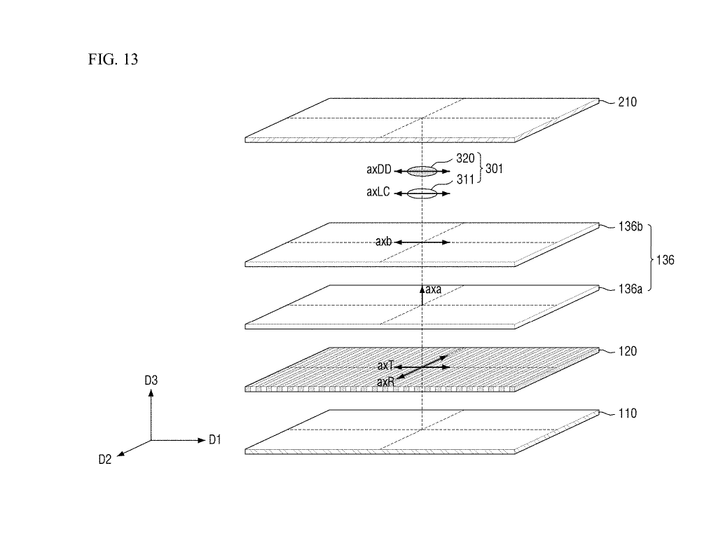

FIG. 13 is a diagram for explaining an optical axis of a display device according to still another alternative embodiment of the invention.

Referring to FIG. 13, such an embodiment of a display device differs from an exemplary embodiment of the display device 31 described above with reference to FIGS. 1 and 2 in that a ground axis (e.g., the ground axis axb of the second phase difference layer 131b) of a phase difference layer 136 is parallel to the transmission axis axT of the polarizing element 120. When the phase difference layer 136 includes a first phase difference layer 136a having no difference in refractive index in the in-plane direction and having the optical axis axa in the thickness direction, and a second phase difference layer 136b having a difference in refractive index in the in-plane direction, the ground axis of the phase difference layer 136 means a ground axis axb of the second phase difference layer 136b. In such an embodiment, the contrast ratio of the display device may be improved by setting the polarization direction (i.e., first direction) of light transmitted through the polarizing element 120 to be parallel with the ground axis of the phase difference layer 136.

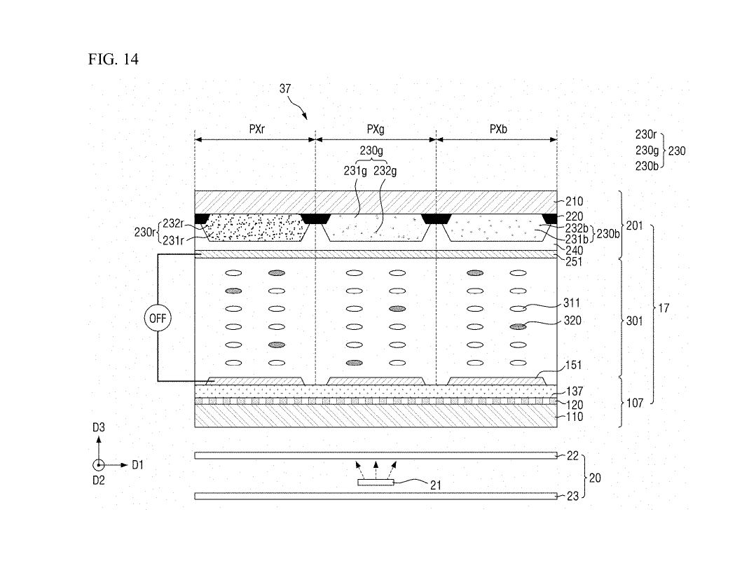

FIG. 14 is a cross-sectional view of a display device according to still another alternative embodiment of the invention.

Referring to FIG. 14, such an embodiment of the display device 37 differs from an exemplary embodiment of the display device 31 described above with reference to FIG. 1 in that a phase difference layer 137 is made up of only a single biaxial phase difference layer that satisfies the following relationship: nₓ≠n_{y}≠n_{z}.

In such an embodiment, the phase difference layer 137 may be a biaxial phase difference layer that satisfies the following relationship: nₓ>n_{z}>n_{y}. Further, an Nz coefficient defined by a value of (nₓ−n_{z}) to the value of (nₓ−n_{y}) of the phase difference layer 137 may be greater than about zero (0) and less than about 1. In some embodiments, the Nz coefficient of the phase difference layer 137 may be approximately 0.4 or more and 0.6 or less, or approximately 0.5. In such an embodiment, the ground axis of the phase difference layer 137 may be parallel to the transmission axis or the reflection axis of the polarizing element 120.

Hereinafter, exemplary embodiments of the invention will be described in greater detail with reference to comparative examples and experimental examples according to an exemplary embodiment of the invention.

### Experimental Example

A display panel that includes a liquid crystal layer interposed between the two insulating substrates facing each other and containing a liquid crystal and dichroic dye, a wire grid polarizer layer, a positive type uniaxial phase difference layer that satisfies the following relationship: n_{z}>nₓ=n_{y}, a negative type uniaxial phase difference layer that satisfies the following relationship: nₓ<n_{y}=n_{z}, and a pixel electrode and a common electrode configured to apply a vertical electric field to the liquid crystal layer, which are sequentially stacked between the lower insulating substrate and the liquid crystal layer, is prepared, and viewing angle characteristics when applying about 0.1 volt (V) and about 15 V were measured, respectively, and a contrast ratio quantification was performed by providing blue light from the lower side of the display panel. The contrast ratio was quantified by measuring a difference in luminance when applying about 0.1 V and luminance when applying about 15 V. Another polarizing element was not disposed outside the display panel at this time.

### Comparative Example

a display panel that is substantially the same as the display panel according to the experimental example described above except that no phase difference layer is disposed between the lower insulating substrate and the liquid crystal layer, and viewing angle characteristics when applying about 0.1 V and about 15 V were measured, respectively, and a contrast ratio quantification was performed by providing blue light from the lower side thereof. Another polarizing element was not disposed outside the display panel at this time.

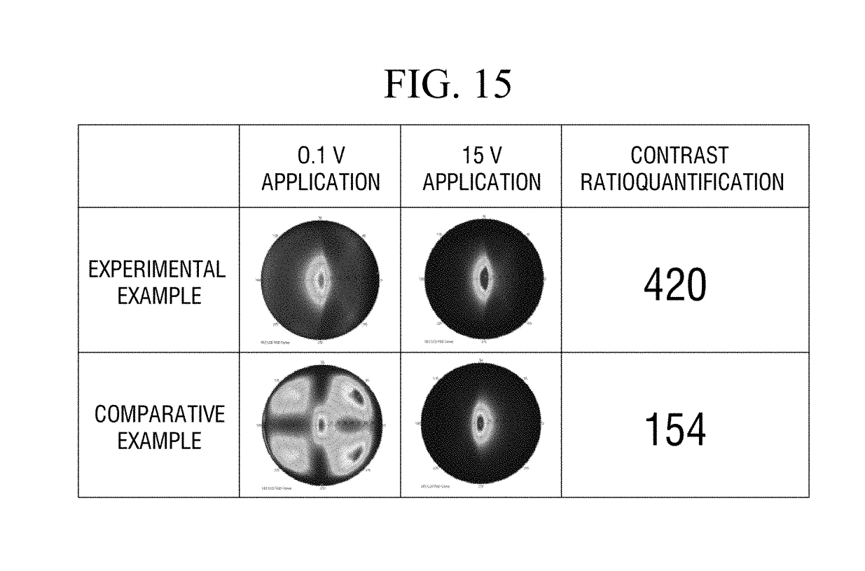

FIG. 15 is a result obtained by measuring the viewing angle characteristics and the contrast ratio on the basis of experimental examples and comparative examples.

Referring to FIG. 15, it is shown that, in the display panel according to the experimental example, light leakage visible from the side in the case of applying a low voltage (e.g., about 0.1 V) is relatively smaller than the display panel according to the comparative example. Further, it is shown that the display panel according to the experimental example have higher contrast ratio with improvement in viewing angle characteristics, as compared to the display panel according to the comparative example.

While the invention has been particularly illustrated and described with reference to exemplary embodiments thereof, it will be understood by those of ordinary skill in the art that various changes in form and detail may be made therein without departing from the spirit and scope of the invention as defined by the following claims. The exemplary embodiments should be considered in a descriptive sense only and not for purposes of limitation.

What is claimed is:

1. A display device in which a plurality of pixels is defined, the display device comprising:
a first insulating substrate;
a polarizer disposed on a surface of the first insulating substrate;
a second insulating substrate which faces the surface of the first insulating substrate; and
a liquid crystal layer interposed between the polarizer and the second insulating substrate,
wherein the liquid crystal layer comprises liquid crystals and a dichroic dye.

2. The display device of claim 1, wherein
the plurality of pixels comprises a first pixel which displays a first color, and a second pixel which displays a second color different from the first color, and
the display device further comprises:
a first wavelength conversion layer disposed in the first pixel, wherein the first wavelength conversion layer comprises a first wavelength conversion material which converts a central wavelength of incident light into a wavelength of the first color; and
a second wavelength conversion layer disposed in the second pixel, wherein the second wavelength conversion layer comprises a second wavelength conversion material which converts the central wavelength of the incident light into a wavelength of the second color.

3. The display device of claim 2, wherein
the first wavelength conversion layer and the second wavelength conversion layer are disposed between the second insulating substrate and the liquid crystal layer.

4. The display device of claim 3, wherein
each of the first wavelength conversion material and the second wavelength conversion material comprises a quantum dot, a quantum rod or a phosphor material.

5. The display device of claim 3, wherein the polarizing element is a reflective polarizer.

6. The display device of claim 5, further comprising:
a phase difference layer disposed between the reflective polarizer and the liquid crystal layer.

7. The display device of claim 6, wherein the phase difference layer comprises:
a first phase difference layer disposed on the reflective polarizer, wherein the first phase difference layer is a uniaxial phase difference layer; and
a second phase difference layer disposed on the first phase difference layer, wherein the second phase difference layer is a uniaxial phase difference layer.

8. The display device of claim 6, wherein the phase difference layer comprises:
a first phase difference layer disposed on the reflective polarizer, wherein the first phase difference layer is a uniaxial phase difference layer; and
a second phase difference layer disposed on the first phase difference layer, wherein the second phase difference layer is a biaxial phase difference layer.

9. The display device of claim 6, wherein the phase difference layer comprises a biaxial phase difference layer having an Nz coefficient greater than zero and less than about 1.

10. The display device of claim 6, wherein a ground axis of the phase difference layer is parallel to a transmission axis or a reflection axis of the reflective polarizer.

11. The display device of claim 10, further comprising:
a pixel electrode disposed between the phase difference layer and the liquid crystal layer,
wherein the pixel electrode is disposed in each of the plurality of pixels.

12. The display device of claim 2, wherein
the plurality of pixels further comprises a third pixel which displays a third color different from the first color and the second color, and
the display device further comprises a light transmitting layer disposed on the third pixel.

13. The display device of claim 12, further comprising:
a light source disposed on an opposite surface of the first insulating substrate,
wherein the light source emits light having a central wavelength shorter than a central wavelength of the first color and a central wavelength of the second color.

14. The display device of claim 13, wherein the light transmitting layer comprises:
a light transmitting resin; and
a light scattering particle dispersed in the light transmitting resin.

15. The display device of claim 1, wherein an azimuth formed by a long axis of the liquid crystal on a plane in an initial alignment state where no electric field is applied to the liquid crystal layer is parallel to the transmission axis of the polarizer.

16. The display device of claim 1, wherein an azimuth formed by a long axis of the liquid crystal on a plane in a state where an electric field is applied to the liquid crystal layer is parallel to the transmission axis of the polarizer.

17. The display device of claim 1, wherein
the liquid crystal layer is a twisted nematic phase liquid crystal layer, and
a long axis of the liquid crystal in a state where an electric field is applied to the liquid crystal layer intersects with the transmission axis of the polarizer.

18. The display device of claim 1, further comprising:
a light source disposed on an opposite surface of the first insulating substrate,
wherein light from the light source and transmitted through the first insulating substrate is in an unpolarized state.
